(19) United States
(12) Patent Application Publication
(10) Pub. No.: US 2026/0318421 A1
(43) Pub. Date: Oct. 15, 2026

(54) SELF-LOCKING SEALS AND SELF-ENERGIZING SEATS FOR VALVES

(71) Applicant: Don Atencio, Tomball, TX (US)

(72) Inventor: Don Atencio, Tomball, TX (US)

(21) Appl. No.: 19/644,833

(22) Filed: Apr. 10, 2026

Related U.S. Application Data
(60) Provisional application No. 63/786,806, filed on Apr. 10, 2025.

(51) Int. Cl. F16K 3/20; F16K 3/02

(52) U.S. Cl. CPC F16K 3/207; F16K 3/0227

(57) ABSTRACT

Self-energizing seats and self-locking seals (“SES” and “SLS” respectively) for valves- and valves containing them. The self-energizing seats use check seals to allow pressurized fluid from the bore to become trapped and exert a force that urges the seat against the valve gate. The self-locking seals use one or more check seals to allow pressurized fluid from the bore to travel up into the valve body but because of their one-way valve function, they maintain contact between the seat and the gate of the valve even when bore pressure drops or when flow through the bore is in a direction which would tend to push the seat away from the gate. Embodiments of the invention also provide redundantly sealed valves and smart valves which can be monitored with one or more sensors.

### CROSS-REFERENCE TO RELATED APPLICATIONS

This application claims priority to and the benefit of the filing of U.S. Provisional Patent Application No. 63/786,806, entitled “Self-Locking Seats and Self-Energizing Seals for Valves”, filed on Apr. 10, 2025, and the specification thereof is incorporated herein by reference.

### BACKGROUND OF THE INVENTION

Embodiments of the present invention relate to self-locking seals and self-energizing seats that can be incorporated into the construction of new valves and/or can be retrofitted onto existing valves—most preferably without requiring further machining or modification to the valve body. Embodiments of the present invention can thus provide valves that can be used in the field and require less greasing because the valves protect the grease from being forced out and from having debris forced into the valve body.

### BRIEF SUMMARY OF EMBODIMENTS OF THE PRESENT INVENTION

Embodiments of the present invention relate to a self-energizing valve seat having an inner seat; an outer seat, the outer seat having dimensions that allow it to at least partially encircle the inner seat; the inner seat having at least two different outside diameters; the outer seat having at least two different inside diameters; and a plurality of check seals positioned to control a flow of a fluid traveling along one or more interfacing surfaces of the inner seat and the outer seat. The self-energizing valve seat can also include one or more preload springs. A first of the plurality of check seals can be positioned to control the flow of the fluid traveling along a first of the at least two different outside diameters. A second of the plurality of check seals can be positioned to control the flow of the fluid traveling along a second of the at least two different diameters. The at least two different outside diameters of the inner seat and the at least two different inside diameters of the outer seat form a gap between the inner seat and the outer seat. The self-energizing valve seat can be disposed within a valve, which valve can optionally have a plurality of electrical sensors disposed on the valve and positioned to monitor one or more positions or conditions of the valve.

Embodiments of the present invention also relate to a self-locking valve seal having an inner seat; an outer seat; a pair of check seals positioned and biased such that when installed in a valve, they allow pressurized fluid to enter an area between them but wherein the pair of check seals are oriented to disallow the pressurized fluid to escape past them after the pressurized fluid has entered the area between them; and the pair of check seals further positioned such that force generated by the pressurized fluid that has entered the space between them causes the self-locking valve seal to exert a force against a gate of the valve. A first of the pair of check seals can be positioned on the inner seat and a second of the pair of check seals can be positioned on the outer seat. A width of the inner seat can be less at its proximal gate contacting surface than its width at a distal end thereof. A width of the outer seat can be greater at its proximal gate contacting surface than its width at distal end thereof.

In one embodiment, the outer seat can have dimensions that allow it to at least partially encircle the inner seat and the inner seat can have at least two different outside diameters-the outer seat can have at least two different inside diameters, and further having a second plurality of check seals positioned to control a flow of a fluid traveling along one or more interfacing surfaces of the inner seat and the outer seat. The self-locking valve seal can have at least one pre-load spring. The at least one pre-load spring can be disposed within at least one pocket of the inner seat and the at least one pre-load spring can be positioned to exert a force that urges the inner seat toward the gate of the valve. The self-locking valve seat can be disposed within the valve, and the valve can optionally have a plurality of sensors disposed on the valve and positioned to monitor one or more positions or conditions of the valve.

Embodiments of the present invention also relate to a self-energizing valve seat having an inner seat; an outer seat-the outer seat having dimensions that allow it to at least partially encircle the inner seat; a polymer seal having a tip and a base and positioned to at least partially translate; and an internal passage leading from a first surface of at least one of the inner seat or the outer seat to an area below the base of the polymer seal. The internal passage can be disposed within the inner seat. The tip of the polymer seal can be disposed between an outer surface of the inner seat and an inner surface of the outer seat. The first surface can be a surface on which a pre-load spring is disposed. The self-energizing valve seat can be disposed within a valve, which can optionally have a plurality of sensors disposed on the valve and positioned to monitor one or more positions or conditions of the valve.

Embodiments of the present invention also relate to a redundantly sealed valve having a first canister seal; a second canister seal, the second canister seal positioned to provide redundant sealing of the first canister seal; a first bonnet seal ring; a second bonnet seal ring, the second bonnet seal ring positioned to provide redundant sealing of the first bonnet seal ring; a first stem packing; and a second stem packing, the second stem packing positioned to provide redundant sealing of the first stem packing. The redundantly sealed valve can have a first leak port communicably coupled to a location within the redundantly sealed valve that can be between the first stem packing and the second stem packing. The redundantly sealed valve can also have a primary stem gland and a second stem gland. The redundantly sealed valve can also have a plurality of electrical sensors positioned to monitor one or more positions or conditions of the redundantly sealed valve. The redundantly sealed valve can also have a self-locking valve seal, which itself has an inner seat, the inner seat having at least two different outside diameters; an outer seat, the outer seat having dimensions that allow it to at least partially encircle the inner seat; the outer seat having at least two different inside diameters; a pair of check seals positioned and biased such that when installed in the valve, they allow pressurized fluid to enter an area between them but wherein the pair of check seals are oriented to disallow the pressurized fluid to escape past them after the pressurized fluid has entered the area between them, the pair of check seals further positioned such that force generated by the pressurized fluid that has entered the space between them causes the self-locking valve seal to exert a force against a gate of the valve; a second plurality of check seals positioned to control a flow of a fluid traveling along one or more interfacing surfaces of the inner seat and the outer seat; and a plurality of electrical sensors positioned to monitor one or more positions or conditions of the redundantly sealed valve.

Embodiments of the present invention also relate to a method for providing sealing force of a valve seat against a valve gate, the method having allowing pressurized fluid from a bore of the valve to generate differential forces between an inner valve seat and an outer valve seat due to a non-consistent width of each of the inner valve seat and the outer valve seat.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing which illustrates a section view of a valve featuring a self-locking seat;

FIG. 2 is a drawing which illustrates a section view of a self-locking seat for a valve;

FIGS. 3 and 4 are drawings which respectively illustrate an outer seat and an inner seat according to an embodiment of the present invention;

FIG. 5 is a drawing which illustrates the outer seat of FIG. 3 positioned around the inner seat of FIG. 4—a valve gate is provided on this and other drawings to assist the user in understanding positioning/orientation;

FIG. 6 is a drawing which illustrates an embodiment of an SLS with SES;

FIG. 7 is a drawing which illustrates an embodiment of an SES only, with no SLS;

FIG. 8 is a drawing which illustrates a section view of a valve with a polymer version of an SLS according to an embodiment of the present invention;

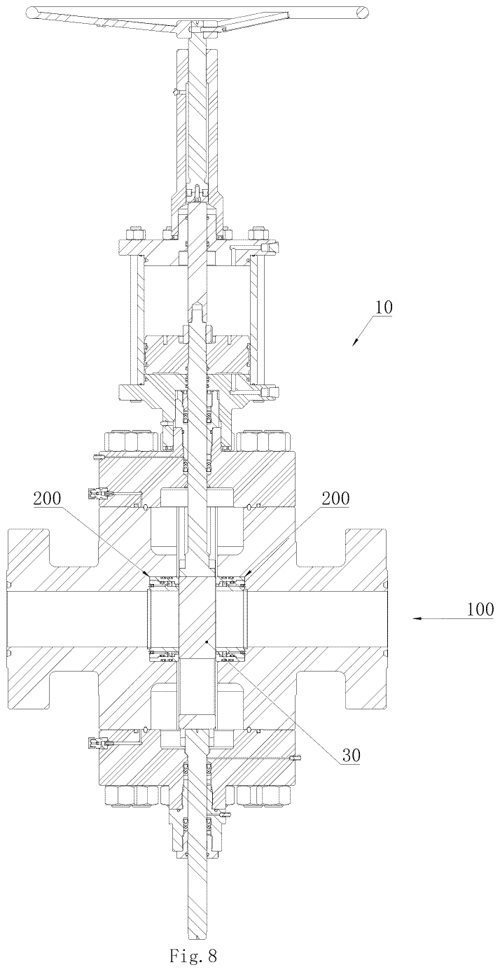

FIG. 9 is a drawing which illustrates a detail section view of a pair of polymer SLS positioned in a valve body with a gate disposed between them;

FIG. 10A is a drawing which illustrates a section views of a polymer SLS according to an embodiment of the present invention;

FIG. 10B is drawing which illustrates a section views of a polymer SLS according to an embodiment of the present invention which includes additional optional seals that are not otherwise illustrated in FIG. 10A;

FIG. 11 is a drawing which illustrates a section view taken lengthwise through the bore of a valve with a pair of polymer SLS according to an embodiment of the present invention;

FIG. 12 is a section view of valve seat featuring a bridge seal disposed between an inner seat and an outer seat; and

FIG. 13 is a drawing which illustrates a universal double stem sealing valve configuration according to an embodiment of the present invention; and

FIG. 14 is a drawing which illustrates an embodiment of a smart valve having one or more sensors.

### DETAILED DESCRIPTION OF THE INVENTION

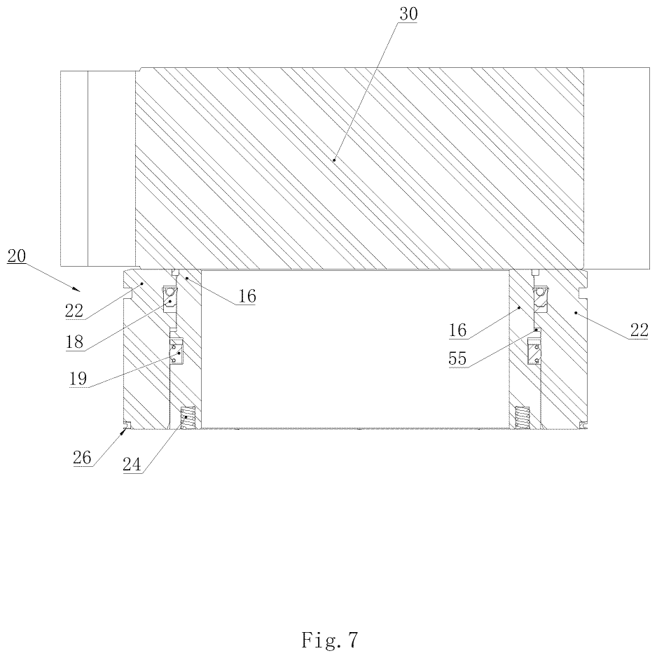

Referring now to the drawings generally, embodiments of the present invention preferably deviate from conventional unibody valve seat construction and instead provide a split configuration whereby a single valve seat now has an inner seat component (the “inner seat”) which is disposed within an outer seat component (the “outer seat”), most preferably with a small gap between interfacing surfaces (see reference number 55 at FIG. 7). Because of this unique dual seat configuration, the two can optionally move together or move independently with respect to one another. With such independent motion, a differential force can be created such that one of the valve seats can exert a greater force against the valve gate.

Embodiments of the present invention relate to valves and more particularly valves which featuring at least one self-locking seat (“SLS”, also occasionally referred to herein as “SLS-M” for embodiments wherein the material which presses against the gate is metal). Embodiments of the present invention also relate to a valve which features at least one self-energizing seats (“SES”, also occasionally referred to herein as “SES-M” for embodiments where the material which presses against the gate is metal). Optionally, the SLS-M, the SES-M, and the self-energizing polymer seat described herein can be incorporated into new-construction valves and/or can be retrofitted into existing conventional valves without requiring a change or modification to the body of the existing valve. Optionally, the SLS and the SES can be configured together into a single valve. Optionally, the SES can be provided in a valve without the SLS feature. And likewise, the SLS can be provided on a valve without the SES.

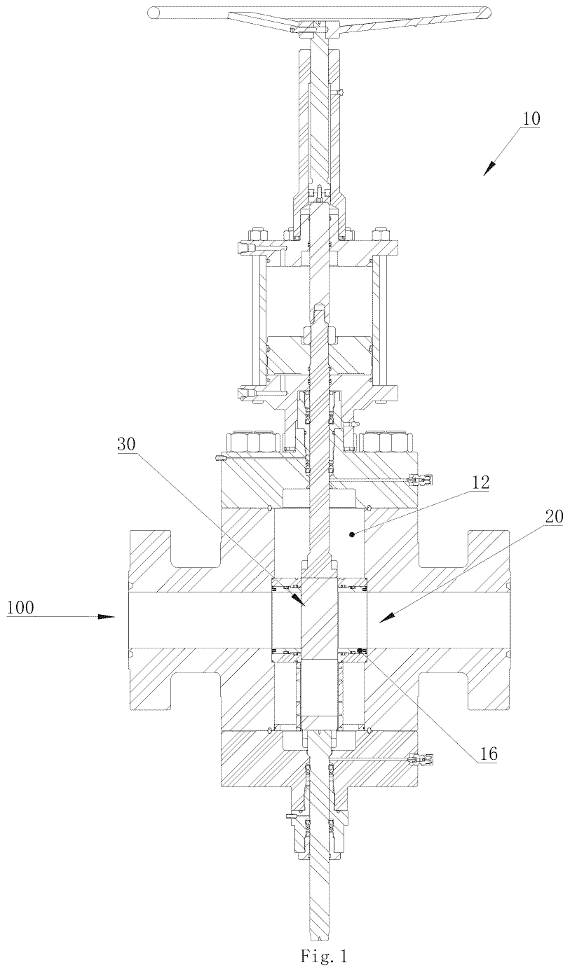

As best illustrated in FIG. 1, Valve 10 can be configured as an SES in combination with an SLS and thus preferably self-activates using the natural internal pressure of fluid in bore 100 of valve 10. When pressurized fluid enters body cavity 12 by leaking past inner seat 16 and outer seat 22 of seat assembly 20, alongside gate 30, which pressurized fluid was contained in or otherwise passing through bore 100, it can be trapped therein even when pressure within bore drops. This is because embodiments of the present invention can ensure a tight fit between the face of the seat and the gate. In one embodiment, a small amount of pressurized fluid is allowed to flow from bore 100 past check seal 15, but is prevented from passing check seal 14 and is prevented from flowing back into bore 100 by check seal 15. This is because those check seals are oriented such that pressure can enter between them but can then not escape past them. Accordingly, they lock the pressurized fluid in place—even when the pressure in bore 100 drops. Because the pressurized fluid is thus locked between them at the opposing side of the seats from the gate, the pressure of the fluid therein applies a force urging seat assembly 20 toward gate 30. Accordingly, even when pressure within the bore drops, any pressure that is trapped in body cavity 12 also remains trapped and unable to escape past the gate/seat assembly or past the seat.

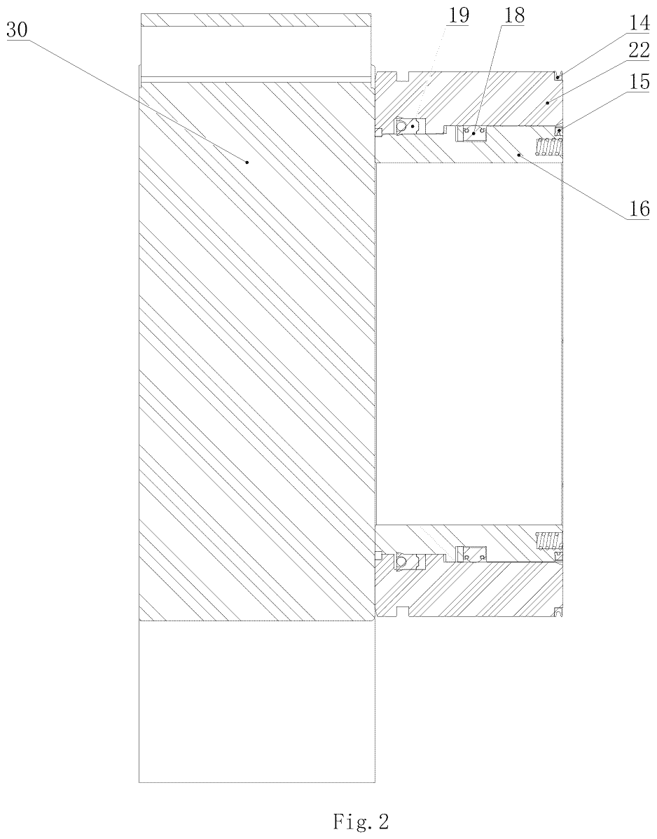

In one embodiment, the check seals are preferably peak seals which are flexible with respect to the seal pocket such that they function like check valves in that the pressurized fluid presses the tip of the seal away from an inner surface of the pocket in one direction, but once the pressure of the fluid that has bypassed the seal is in equilibrium with the fluid entering the seal, or is greater than the pressure attempting to flow past the seal, the seal is forced back against the seal pocket, thus trapping the pressurized fluid from flowing back past the check seal in an opposite direction. The use of the check seals to trap pressurized fluid at strategic locations in a valve seat assembly thus provides the SES feature. The trapped pressurized fluid maintains a constant applied force and face-to-face high force contact between inner seat ring 16 and gate 30. This forced contact prevents pressure from fluid within body cavity 12 from leaking back out between the seal and the gate, which would tend to carry off grease from within body cavity 12 when pressure within bore 100 drops. This forced contact also prevents intrusion of sands or abrasives into body cavity 12. In addition, because inner seat 16 and outer seat 22 have a stepped configuration such that inner seat 16 has a larger outside diameter on its portion that is further from gate 30 than its outside diameter that is closest to gate 30 (see for example FIG. 2), it allows the creation of a pressure differential between inner seat 16 and outer seat 22. The pressurized fluid enters from bore 100 and is allowed to flow past check seal 15 but is stopped by check seal 14. Optionally, check seals 15 and 14 can be provided on a conventional unibody valve seat such that they trap pressurized fluid between them and thus provide increased seat-gate contact.

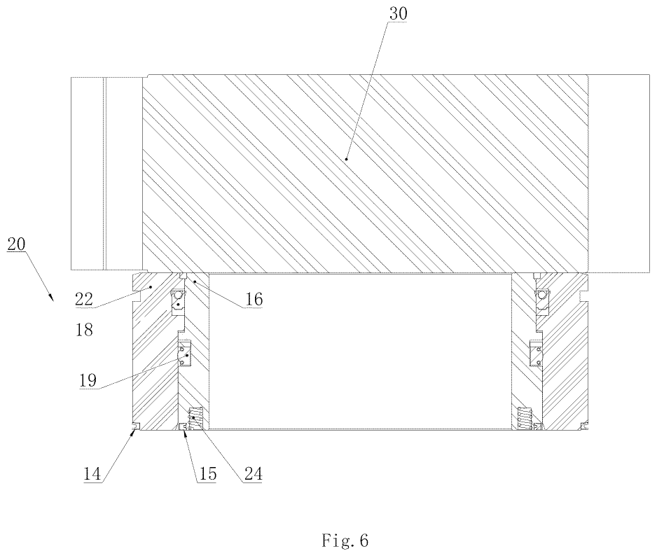

In one embodiment, wherein an SLS and SES functions are provided in a single seat assembly (see for example FIG. 6), although the pressurized fluid may try to force its way between inner seat ring 16 and outer seat ring 22, the flow of such pressurized fluid is preferably prevented from doing so because check seal 18 prevents pressurized fluid from reaching gap 55 formed along interfacing surfaces of inner seat 16 and outer seat 22. In addition, check seal 19 likewise prevents pressurized fluid from reaching gap 55. Most preferably, gap 55, is formed at a stair-stepped interfacing area between inner seat 16 and outer seat 22 as illustrated in FIG. 7. Note that although the figures illustrate an embodiment wherein gap 55 is formed along interfacing surface areas of the seats which are shown as being formed at substantially a right angle with respect to the length of seat, it is to be understood that desirable results can be provided even when gap 55 is formed along interfacing surfaces which are not at substantially a right-angle with respect to the length of the seats so long as there is a resulting component force that works in a direction along the length of the seat. Because the location where the changes in diameter of the inner seat 16 and outer seat 22 are protected from intrusion of pressurized fluid by check seals, the pressure there is negligible in comparison with the pressure of fluid pressing in on the inner and outer seats. Accordingly, a differential force is created due to the change in diameter of inner seat 16 and outer seat 22, such that inner seat 16 exerts a force toward gate 30. This resulting force creates a self-energizing seat (“SES”) configuration which is able to hold a greater sealing force against gate 30.

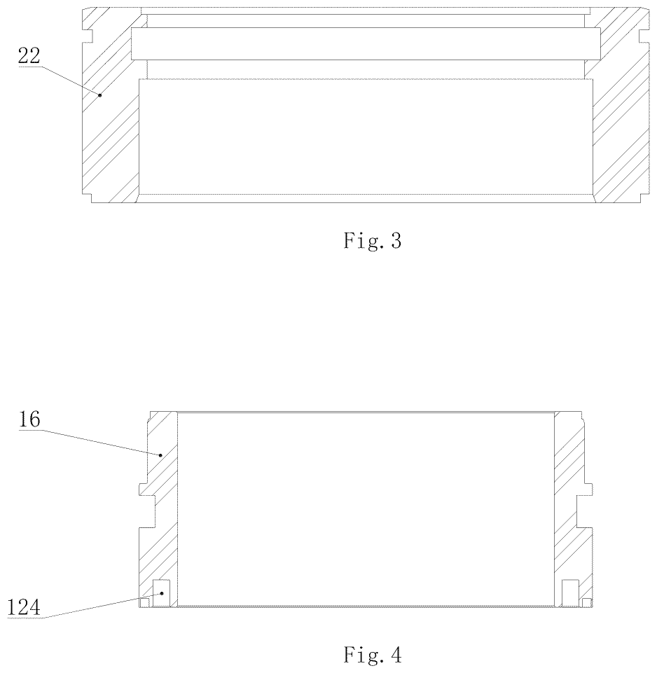

Optionally, valve 10 can be configured for manual operation or hydraulic actuation. FIGS. 3 and 4 respectively illustrate outer seat 22 and inner seat 16, along with some of the various seal pockets that can be provided (as well as an example of spring pocket 124, which can be provided for receiving spring 24).

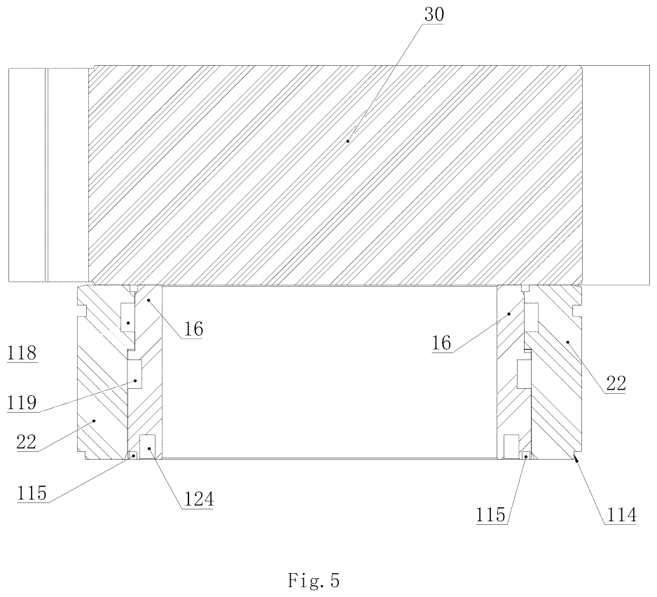

FIG. 5 illustrates inner seat 16 and outer seat 22 without the various seals disposed therein, such that the various seal pockets are illustrated. In this embodiment, seal pocket 114 is provided for seal 14 (see FIG. 6), seal pocket 115 for seal 15 (see FIG. 6), seal pocket 118 for seal 18 (see FIG. 6), and seal pocket 119 for seal 19 (see FIG. 6) (note that the pockets are illustrated in FIG. 5, while FIG. 6 illustrates an embodiment wherein the seals are disposed within the pockets). One or more pockets 124 for one or more springs 24 (see FIG. 6) can also optionally be provided.

Referring now to FIG. 6, seat assembly 20 preferably includes preload spring 24 positioned to apply a force to inner seat 16 to contact gate 30 (see FIG. 1) to help create the initial sealing action. Spring 24 is preferably a pushing-type spring and exerts force against an internal sidewall of the valve body that forms the cavity that holds seat assembly 20. First seat seal 18 is preferably also a check seal that prevents pressurized fluid to flow away from bore 100 and thus protects interfacing gap 55. Seal 19 performs the same function, but from the opposite direction. As illustrated by the drawings there are several ways to configure the seals, the spring, and check seals to achieve different results for any desired application.

As best illustrated in the embodiment of FIG. 7, an SES configuration can be provided without the SLS feature. In this embodiment, the SES configuration, preferably self-activates by using the differential pressure created by the differing stepped diameters of inner seat 16 and outer seat 22 via the internal pressure that is caused by pressurized fluid from bore 100 of valve 10. Without the SLS, in embodiments where only SES is provided, the inner check seal 15 (see FIG. 2) is preferably not provided. Thus, pressurized fluid is allowed to escape back into bore 100 when pressure within bore 100 drops, such that the pressurized fluid is not locked between inner seat 16 and outer seat 22. When the pressure of fluid in bore 100 rises, the area between first seat seal 18 and second seat seal 19 is protected from the pressurized fluid by the check seals. In this configuration the pressure can enter the body cavity 12 by two ways. One way is that it can enter by passing check seal 26 or by entering body cavity 12 during the cycling of gate 30 as seen in FIG. 2. Because of the differences in the diameters of the two end faces of inner seat 16 and because all or a portion of that difference is protected from encountering the pressures which act on the ends of inner seat 16, it will always have applied force regardless of the pressure in bore 100. Inner seat 16 is able to apply force against gate 30 because it has a larger surface area at its opposite end (the end opposite that which abuts gate 30) than outer seat 22. In one embodiment, SLS and SES can both have one or more internal preload springs 24, which are most preferably disposed within pockets 124 of inner seat 16. One or more springs 24 are configured to apply and maintain a force to urge a face of inner seat 16 and/or outer seat 22 against gate 30.

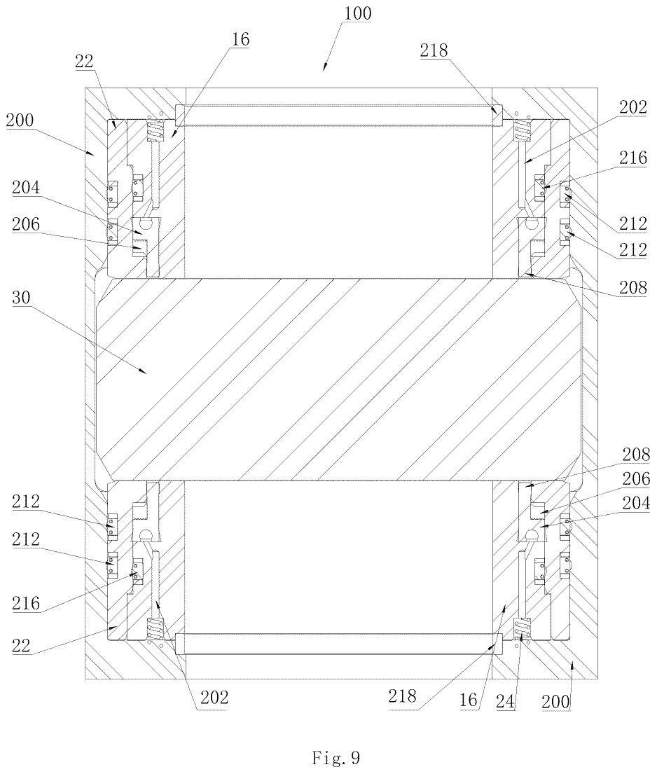

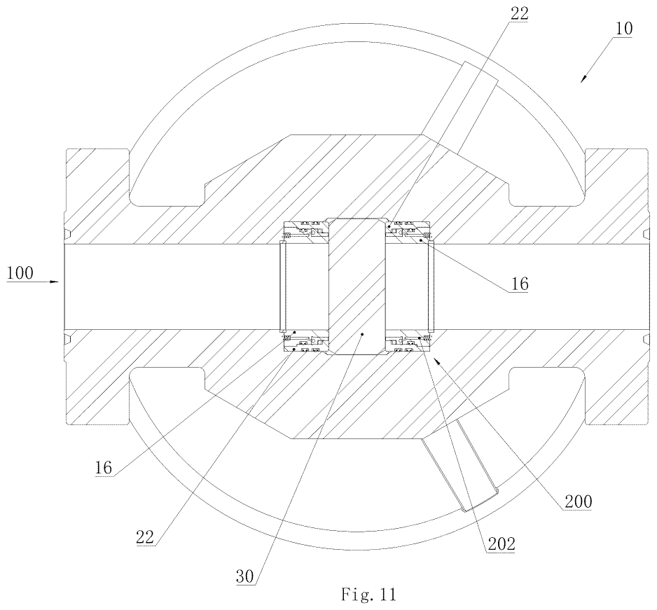

Referring now to FIGS. 9-11, various views of a polymer SLS, wherein the seal that is pressed against gate 30 is preferably formed from a polymer material, which can optionally be an elastomer, including for example rubber and and/or synthetic elastomeric materials. Although in one embodiment an elastomer is preferably used, polymers having elastic strain limits even lower than elastomers can be used. In this embodiment, polymer SLS 200 preferably includes port 202, which is preferably a port that conveys pressurized fluid from bore 100 of valve 10 (which pressurized fluid has seeped between polymer SLS 200 and the pocket that retains it in valve 10) to energize lower seal 204, which is most preferably formed from a polymeric material. The pressure pushes seal retainer ring 206 (which is most preferably formed from a metal material), and thus polymer seal 208 against the valve gate (not shown) such that polymer seal 208 is then compressed against inner seat 16 and outer seat 22 and forced to elastically deform and effectively provide a molded seal against the gate with enough force that polymer seal 208 contours and conforms around any damage or imperfection that may be present on the gate in order to achieve a 100% seal.

In one embodiment of polymer SLS 200, outer seat 22, preferably has a stair-stepped internal profile such that three dissimilar internal diameters are provided. Polymer SLS 200 capitalizes on the pressure of fluid in bore 100 to provide additional force for seating polymer SLS 200 against gate 30. Polymer SLS 200 is preferably fitted with pre-load spring 24, which applies force to inner seat 16. The pressurized fluid is preferably stopped by seals 216, and 212. This pressurized fluid exerts force on inner seat 16, which applies force against the gate to create the first seal barrier. In addition, polymer SLS 200 is preferably also fitted with a unique active polymer seal assembly wherein seal 208 provides a second sealing barrier against gate 30. Polymer seal 208 is preferably by-directional such that when gate 30 is sandwiched between a pair of polymer SLS 200, they can each seal a respective side of gate 30, regardless of the flow of fluid within bore 100. In one embodiment, polymer seal 208 is preferably molded and adhered to seal retaining ring 206. This provides a no-go to stop seal 204, from being forced out of its pocket.

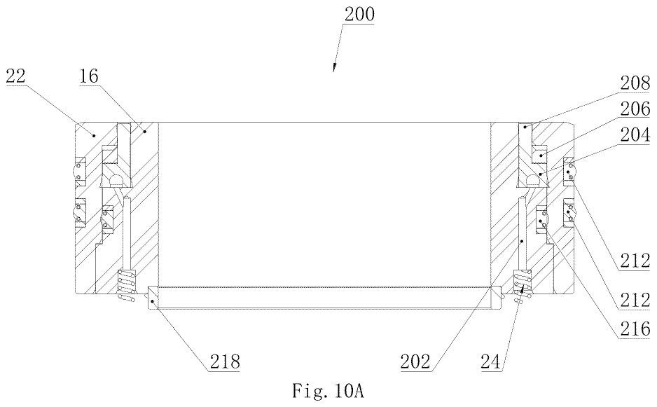

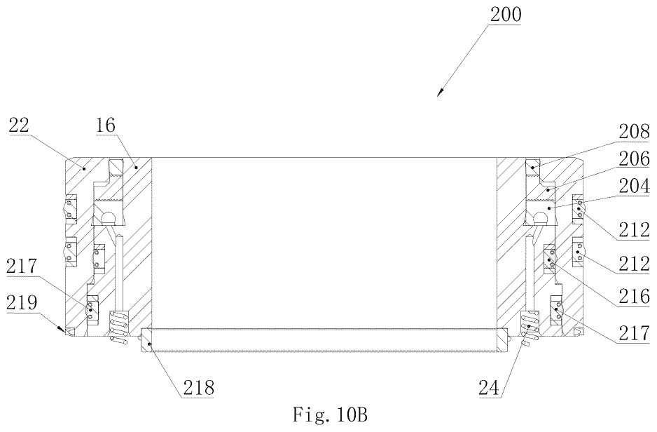

Polymer seal 208 preferably provides variable in and/or out (translating) movement. S-seals 212 are preferably positioned around an outer diameter of outer seat 22 to seal between the body cavity and outer seat 22. Optionally, an inner minor polymer seal 217 (see FIG. 10B) can be provided and if so, is preferably one or more s-seals placed around an outer diameter of the inner primary seat ring, which isolates inner ring seal 216, the lower seal from pressurized fluid that would otherwise encounter it, and keeps the pressure directed to the lower seal 204. Optionally, backup seal 219 can be provided (see FIG. 10B)-most preferably around an exterior of outer seat 22 (for example below S-seals 212). The back up seal can be a check seal that provides additional backup protection. Sand barrier ring 218 is also preferably provided. One or more preload springs 24 are also preferably provided to help keep the sealing face in contact with gate 30. Bore 100 is at least partially defined by the inside diameter of inner seat 16.

The pressurized fluid in bore 100 by-passes through sand barrier ring 218 to the backup seal (if provided). Pressure pushes inner ring polymer seal 216 between inner seat 16 and outer seat 11. Outer seat 22 creates an applied force on inner seat 16 generated from the internal pressure of fluid in the body cavity. The applied force depends on the variable internal pressures that are generated in bore 100, the force that is applied to inner seat 16 drives polymer seal 208 against the gate (not shown) this applied force will convinces polymer seal 208 to conform itself to any scaring damage, or imperfections on surfaces of the seat or the gate which it is forced against, thus creating a seal regardless of the damage at those locations of those surfaces (and regardless of whether a metal face surface of SLS 200 itself is scratched or otherwise deformed). This contact prevents intrusion of sand or abrasives and prevents grease from escaping. Outer seat 22 also has two different inner diameters that are encountered by inner seat 16.

In one embodiment, outer seat 22 is fitted with one or more inner ring seals 216. Inner ring seals 216 isolate outer lower seal 217 (see FIG. 10B) on an inner seal groove on outer seat 22—this isolates the pressure away from seal outer lower seal 217. By isolating outer lower seal 217, it prevents the larger diameter from equalizing the larger diameter on outer seat 22. By calculating the two different diameters and subtracting the two, it results in the difference, which is the net of applied force. Inner seat 16 is now able to apply a force against the gate from both directions (i.e. from the seal assembly that is positioned on each side of the gate)—this is true regardless of whether the gate is in the open or closed position. When gate 30 is in the open position, the force from both inner seats are applied evenly. This makes it possible to hold 100% pressure in the bore. However, when the gate is in the closed position, the upstream seat will apply force to the gate, also isolating 100% pressure in the bore. Polymer seal 208 is preferably energized by pressure entering port 202 from the well bore. In one embodiment, polymer seal 208 most preferably has three sections, upper polymer seal 208 seal retainer ring 206, and lower seal 204. Each of upper seal 208, seal retainer ring 206, and lower seal 204 are preferably at least partially energized by pressure of fluid that enters through port 202. This pressure comes from bore 100 and thus energizes lower seal 204. The pressure also causes polymer seal 208 into contact against the valve gate (not shown) such that polymer seal 208 is forced to bulge outward to thereby compress against a portion of inner seat 16, outer seat 22 and gate 30 to compress polymer seal 208 with enough force to conform to damage of imperfection (if any exists) in order to achieve a non-leaking seal.

Optionally, polymer seal 208 can be adhered to, formed around or otherwise coupled to a non-polymer material. Most preferably, however, the material which is forced into contact with the gate is formed from a polymer and can thus provide greater elastic deformation which is significantly greater than that used for conventional high-pressure valves, such that the polymer can elastically deform around any defects that may be present on the gate. In one embodiment, the polymer is an elastomer. In one embodiment, the polymer has an elastic strain limit of at least 2%, more preferably at least 5% and most preferably at least 20%.

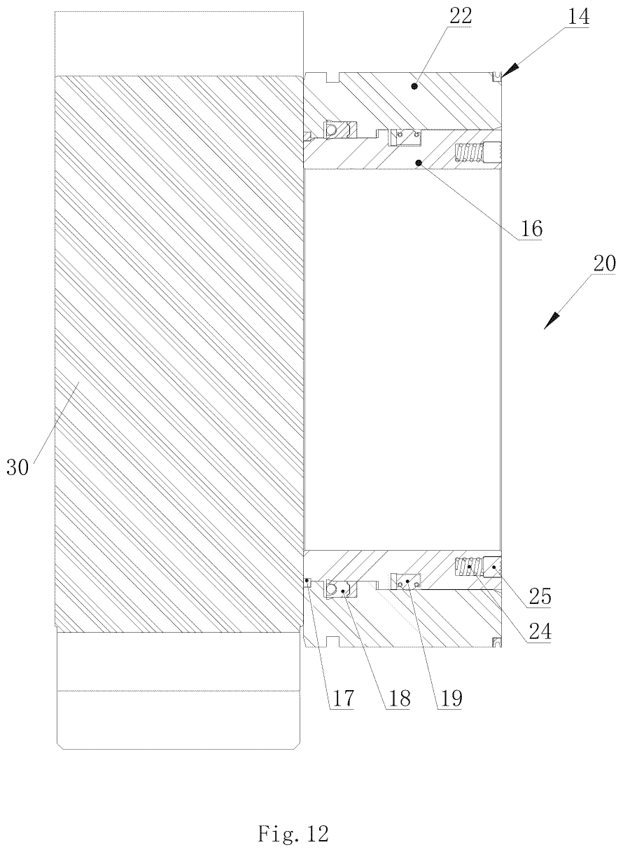

Referring now to FIG. 12, in one embodiment, seat assembly 22 can include bridge seal 17 which is preferably positioned such that it straddles inner seat 16 and outer seat 22. Accordingly, when force is applied via any of inner seat 16, outer seat 22, or a combination of both inner seat 16 and outer seat 22, seal 17 can be activated to compress against gate 30. This unique configuration can optionally be fitted with sand block ring 25, which is preferably activated by force created by pre-load spring 24, which itself serves to simultaneously activate both the sand block ring and activate inner seat 16 (and thus bridge seal 17) against gate 30. Optionally, check seal 14 can be provided.

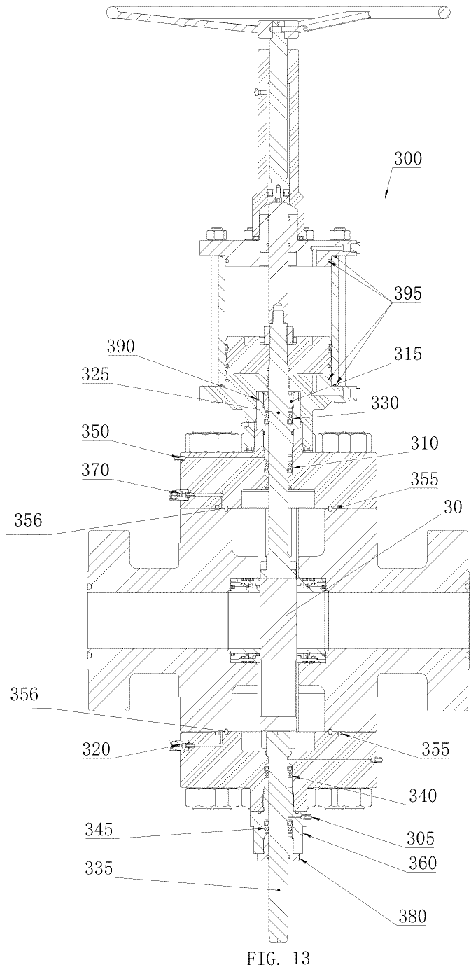

FIG. 13 illustrates redundantly sealed valve 300 according embodiments of the present invention. It is to be noted that although FIG. 13 illustrates a valve having an upper and lower stem, the redundant sealing features described herein can be applied to valves which have only a single stem or to valves having dual stems. Referring now to FIG. 13, in this embodiment, first packing 310 and second packing 330 are provided for upper stem 325, and first packing 340 and second packing 345 are provided for lower stem 335. Redundancy of primary gland 390 is preferably provided by secondary gland 315. Likewise, for embodiments wherein the valve is a dual stem valve, redundancy of primary gland 360 is provided by secondary gland 380. Most preferably, each packing pocket is configured to accept a standard stem packing. Most preferably, leak alert port 350 and leak alert port 305, are provided and are configured to provide a passage for any fluid that leaks past their respective packings (310 and 345). This provides a visual indication to an operator as to whether those packings are functioning or have failed. Likewise, however, a sensor can be coupled to leak alert port 350 and/or leak alert port 305 to provide electronic monitoring to detect the failure of the respective first packings.

Leak alert ports 350 and 305 are preferably loosely covered or plugged to allow any fluid therein to leak out of them so as to provide a visible alert as to the presence of a leak. By allowing fluid to leak at the alert ports, this also prevents pressure from building up against the secondary packings, thereby reducing wear. By providing secondary gland 315 and secondary gland 380, when the respective packing fails and pressurized fluid bypasses primary gland 360 and/or 390, a respective secondary gland exists. Valve 300 also provides service/maintenance reducing features by addressing design weaknesses of conventional valves, including for example safety and environmental weak points. To address the flaws of conventional valves, embodiments of the present invention provide a solution to bonnet seal ring leaks, which leaks can impose deep safety and environmental concerns. Embodiments of the present invention thus provide a secondary (“backup”) bonnet seal ring 355, which provides redundancy for primary bonnet seal 356. Backup bonnet seal ring 355 is preferably disposed on upper (and for dual stem valves, lower) bonnets. Most preferably leak detection ports 370 and 320 are provided and are respectively configured to allow fluid that leaks past primary bonnet seal 356 to flow therein-thus providing visible identification when primary bonnet seal 356 has failed. Likewise, a sensor can optionally be provided to detect the presence of fluid in either or both of leak detection ports 370 to provide an alert as to the failure of primary bonnet seal 356. This configuration allows field personnel to pressure-test the bonnet seal and verify integrity of seals before returning the valve to service. Each of leak detection ports 320, 370, thus provide access to the dual bonnet seal ring for monitoring, testing, verification and integrity testing of the upper lower bonnet seal rings. Double hydraulic canister backup seals 395 provide an additional containment layer of sealing. The redundant valve teachings can be used in conjunction with any of the other aspects of the invention disclosed herein, including SES, SLS, polymer SES, and the smart valve described below.

Once a leak has been made known to an operator—via a leak occurring at a leak detection port. The leak detection port can be closed to seal it off. This then causes pressure to rise behind it. This increase of pressure causes the respective secondary gland and its respective secondary packing to be energized. In a redundantly sealed embodiment, with leak alert port, secondary packing is not pressure energized until the primary packing leaks. When that happens, the leak alert port can then be closed and tightened.

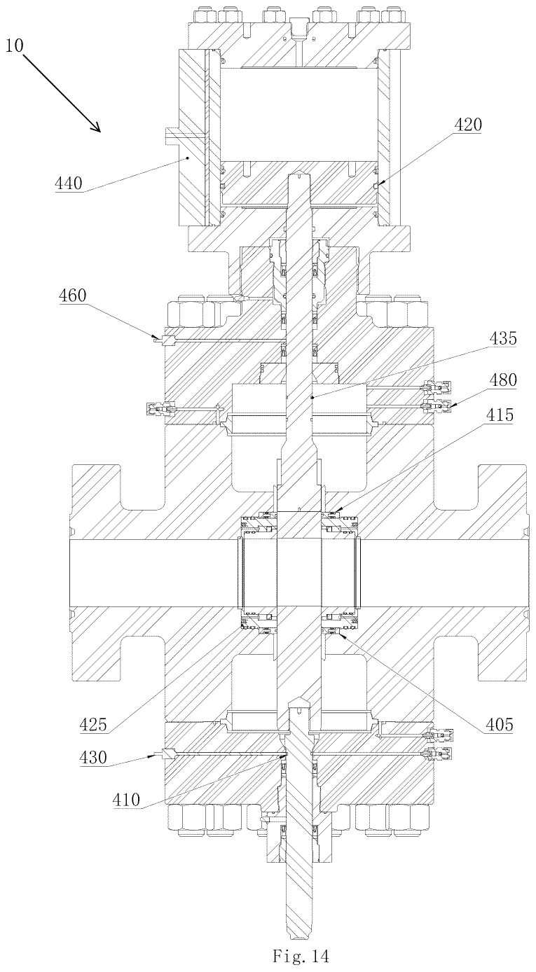

Referring now to FIG. 14, an embodiment of valve 10, which has been configured to provide electronic monitoring and detection (a “smart valve”), is provided. In this embodiment, valve 10 can optionally include one or more sensors, 430, 440, 460, 480, which can include one or more wireless open/closed sensors 420, 425, 410, which can be disposed on or in the valve to provide monitoring. In this embodiment, one or more of the sensors can detect the state and/or condition of the valve (open/closed, leaking at a leak detection port or not leaking at a port) and/or can optionally quantify the amount that the valve is open or closed (for example as a percentage and/or using a scale-for example 0 to 100). Sensors 440 and/or 420, for example, can detect an amount that valve 10 is open or closed. Any of various types of sensors can be used and their position and connection can be placed and as desired. For example, in one embodiment one or more magnets are imbedded or otherwise affixed to a movable portion(s) of the valve and one or more Hall effect sensor is used to detect the presence of the one or more magnets. Optionally, an ultrasonic measuring detector can be used. A variable resistor and/or a digital encoder can optionally be used and can optionally be connected to a portion of the valve directly or through one or more movable linkages or toothed connections. The embodiment can also include a force reduction seal ring 405, and check a seal 415, this ring serves to reduce the force for active seat 425 to maintain applied force. Optionally, upon detection by the sensor, a safety alerts can automatically be generated by a processor and issued to a user via any desired communication mechanism (including for example audibly, visually-which can optionally include via a remote monitoring station alert, an email, an automated telephone call, a text message, a notification on a mobile phone application, combinations thereof and the like). Embodiments of the smart valve can thus include one or more microcontrollers and/or microprocessors and a power supply or power source to provide for monitoring and transmitting of data from valve 10. The smart valve can be incorporated into any of the valves described in this application. For example, the various sensors can be provided to an SLS, an SES (and/or polymer SES), a polymer SES, and/or a redundantly sealed valve.

Optionally, SLS and SES (including polymer SES) can be applied to any conventional valve without machining or modifying the valve body, regardless of the brand or size of the valve. Alternatively, of course, valve 10 can be constructed to include SLS, SES, and/or polymer SES at the time of its original manufacture. Although embodiments can be adapted to any desired working pressure (“WP”), in one embodiment, the following list provides examples of valve sizes and working pressures that can optionally be provided using the teachings made herein:
2 1/16″
3 1/16″
4 1/16″
4 1/16″
5⅛″
7 1/16″
7 1/16″

Embodiments of the present invention relate to a gate valve assembly comprising an upper canister flange configured with dual independent sealing interfaces, wherein each sealing interface independently prevents fluid communication between the valve body interior and the external environment, such that failure of one sealing interface does not compromise the integrity of the other. The gate valve assembly can also include a dual-seal canister configuration incorporating a first seal element disposed proximate the upper canister flange and a second seal element disposed proximate the lower canister flange, wherein both seal elements are independently energized and provide redundant pressure containment along the canister bore. In one embodiment, the lower canister incorporates two axially spaced stem-sealing elements circumferentially engaging the operating stem, the elements establishing independent, redundant fluid barriers that prevent wellbore fluid migration along the stem axis under rated working pressure. The valve body can define upper and lower hydraulic actuation ports, each having a flow passage cross-sectional area sized to deliver high-volume hydraulic fluid for rapid gate actuation, the port geometry minimizing pressure drop during emergency closure operations. The operating stem can be sealed by a dual-packing stack comprising a primary packing set and a secondary packing set, each set independently containing wellbore pressure, the secondary set remaining fully functional upon failure of the primary set without requiring valve removal from service. The gate valve assembly can further include an upper stem leak-monitor port positioned between the primary and secondary packing sets, the port providing annular access to the inter-packing cavity to enable detection, measurement, and controlled venting of any fluid migrating past the primary packing, without breach of the secondary packing barrier. The gate assembly can also include a grease injection port in fluid communication with designated lubrication cavities within the valve body, the port configured to accept a standard high-pressure grease fitting and to distribute lubricant to gate and seat bearing surfaces under full working pressure without actuator removal.

In one embodiment, a bonnet-to-body interface incorporates two concentrically or axially spaced seal rings, each independently resisting rated working pressure, the arrangement providing primary and secondary pressure-containing barriers at the bonnet joint to prevent external leakage. A test port can be provided in the valve body, opening into the inter-seal annulus between the primary and secondary bonnet seal rings, the test port enabling field verification of individual seal-ring integrity by application of hydrostatic or pneumatic test pressure to each seal independently.

Embodiments of the present invention also relate to a valve seat assembly comprising an inner metal seal element configured to establish a primary fluid-tight barrier between the gate and the upstream seat face under differential pressure loading; a center polymer sealing element conforming under pressure activation to surface imperfections, pitting, and minor erosion damage on the gate face to re-establish sealing integrity; and an outer metal seal element providing a tertiary downstream pressure barrier, wherein all three sealing elements act in concert under wellbore differential pressure to create redundant, self-energized sealing. In the closed-gate position the inner metal seal element preferably engages the upstream gate face to form the primary seal barrier, preventing upstream wellbore pressure from communicating to the downstream side of the gate, the metal-to-metal contact geometry being sized to achieve rated pressure containment at the minimum actuator load. The center polymer sealing element is preferably formed from a blowout preventer-grade polymer compound that, upon application of differential pressure, undergoes controlled deformation to fill and conform to scratches, pits, weld splatter, and erosion defects on the gate face surface, thereby restoring a fluid-tight barrier where metal-to-metal sealing alone would be insufficient due to surface damage.

The valve seat assembly can also include a sand-exclusion guard element spring-loaded against the gate face by one or more compression springs, wherein the spring load maintains continuous contact between the guard and gate face during valve operation, preventing the ingress of sand, proppant, and particulate debris into the seating cavity and thereby preserving sealing-element integrity over repeated open/close cycles. The lower bonnet-to-body joint preferably incorporates two axially separated seal ring grooves, each receiving an independent pressure-containing seal ring, establishing redundant primary and secondary sealing at the lower pressure boundary of the bonnet joint.

The gate valve assembly can also include a test port opening into the cavity between the lower primary and secondary bonnet seal rings, thus enabling independent pressure testing of each lower bonnet seal to confirm barrier integrity without disassembly. Optionally, the valve assembly can include a primary stem seal assembly disposed in a gland housing surrounding the operating stem, the primary stem seal being energized by wellbore pressure and actuator load to prevent migration of wellbore fluids along the stem bore under rated working pressure and temperature. In addition, a double secondary backup stem seal assembly can be disposed above the primary stem seal, the backup assembly incorporating two independent sealing elements that maintain full-rated pressure containment independent of the primary stem seal, providing redundant stem-sealing without valve removal upon primary seal degradation. Optionally, a lower stem leak-monitor port can be positioned between the primary stem seal and the double secondary backup stem seal, providing annular access to the inter-seal cavity to enable continuous or periodic monitoring manually or electronically for fluid migration or pressures past the primary stem seal under operating conditions.

Embodiments of the present invention also relate to a gate valve assembly comprising dual active seat members each independently spring-energized and pressure-actuated against the gate faces, wherein in the open-bore position the seat members retain body cavity pressure to prevent uncontrolled pressure communication between the gate cavity and the production bore, maintaining a fluid-isolated body cavity under full working pressure in both the open and closed valve positions. In one embodiment, each active seat member is pressure-actuated against the gate by differential pressure acting on a seat piston area, the resulting seating force being proportional to working pressure, such that sealing force increases with wellbore pressure to maintain rated pressure retention across the seat faces in the full-open bore position. The dual active seat members preferably cooperate to maintain continuous contact with the gate faces in the open position, defining a sealed cavity perimeter that prevents sand, proppant, scale, and other wellbore particulate from entering the body cavity, thereby protecting internal valve components from erosive wear and seat-face damage. The dual active seat members preferably provide a fluid barrier between the production bore and the body cavity in both the fully open and fully closed valve positions with this design the gate will also hold pressure in the upstream side, preventing wellbore pressure from pressurizing the body cavity during normal operation and thereby reducing cyclic pressure loading on bonnet seals, stem packing, and body hardware. The active seat sealing configuration preferably defines a closed annular cavity at the seat-to-gate interface that retains injected lubricant grease within the seating zone during valve operation, preventing grease from migrating into the production bore or the body cavity and thereby extending lubrication service intervals and preserving gate-face surface condition.

Embodiments of the present invention also relate to a gate valve assembly comprising a sand guard shielding element disposed between the seat faces and the body cavity, the element being configured to deflect and exclude particulate matter entrained in the production fluid from contacting and eroding the primary sealing surfaces of the gate and seats, the shielding element maintaining its protective position during full gate travel through the valve bore under rated working pressure and temperature conditions. Optionally, a position-sensing probe can be operably coupled to the hydraulic actuator piston, the probe generating an electrical signal corresponding to the linear displacement of the piston and transmitting the signal via a wired connection or a wireless communication protocol to an external monitoring system, whereby the open or closed position of the gate is continuously indicated without external visual inspection of the actuator. An upper stem position-sensing probe can be disposed within the valve bonnet or actuator housing and operably engaged with the operating stem, the probe generating a discrete or continuous position signal transmitted wirelessly to a surface or remote monitoring receiver, whereby the open or closed state of the gate valve is indicated in real time from the upper stem travel.

In one embodiment, the upper stem packing assembly can include three independent packing elements retained within the stem bore by an internally installed retainer nut, the retainer nut being threaded or otherwise positively secured within the valve bonnet and incorporating a back-sealing interface between the retainer nut and the bonnet bore that prevents wellbore fluid from bypassing the packing stack through the retainer-nut-to-bonnet annulus. An upper bleeder port can be positioned to provide fluid communication with the annular cavity between at least two of the three packing elements, the bleeder port enabling detection of fluid migration past the primary or secondary packing element under operating conditions and providing a controlled venting path to monitor packing wear and service condition without removal of the packing stack. Each active seat member can incorporate a force-reduction ring seated within the outer seat ring groove and positioned to act against the seat actuation load, the force-reduction ring being dimensioned and configured to reduce the net compressive force applied by the active seat against the gate face to a predetermined value, thereby controlling seat-to-gate contact stress, reducing operating torque, and extending seating surface service life under rated working pressure. A lower stem position-sensing probe can be disposed within the lower valve bonnet or packing housing and operably engaged with the operating stem, the probe generating a discrete or continuous position signal transmitted wirelessly to a surface or remote monitoring receiver, whereby the open or closed state of the gate valve is independently confirmed from the lower stem travel, providing redundant position indication with the upper stem probe. The lower stem packing assembly can include three independent packing elements retained within the lower stem bore by an internally installed retainer nut, the retainer nut being threaded or otherwise positively secured within the lower bonnet and incorporating a back-sealing interface that prevents wellbore fluid from bypassing the lower packing stack through the retainer-nut-to-bonnet annulus, the lower packing assembly providing redundant stem sealing symmetric to the upper stem packing assembly. An internal pressure-sensing probe can be disposed within the valve body cavity, the probe being configured to measure fluid pressure within the body cavity and to transmit pressure data wirelessly to an external monitoring system, whereby an increase in body cavity pressure above a baseline value is indicative of seat seal leakage past one or more active seat members, enabling real-time detection of seat degradation and incipient seat failure during valve operation without interruption of production flow.

When reference is made to the ability to check seals to prevent the flow of fluid in one direction past them, it is to be understood that such check seals can include conventional check seals which therefore may allow a very slow rate of leakage or diffusion of pressurized fluid to escape past them-but for all practical purposes when evaluating them on a time scale of several minutes, they prevent the fluid from flowing past them in the direction which they are biased against.

Although the figures and associated text describe examples of configurations wherein the inner valve seat is caused to exert a greater force against the valve gate, the teachings described herein can be swapped (i.e. teachings that impact an outer diameter of the inner gate can instead be applied to an internal diameter of the outer gate) to change the location of the resulting gate-sealing force.

Optionally, embodiments of the present invention can include a general or specific purpose computer or distributed system programmed with computer software implementing steps described above, which computer software may be in any appropriate computer language, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums).

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A self-energizing valve seat comprising:
an inner seat;
an outer seat, said outer seat comprising dimensions that allow it to at least partially encircle said inner seat;
said inner seat comprising at least two different outside diameters;
said outer seat comprising at least two different inside diameters; and
a plurality of check seals positioned to control a flow of a fluid traveling along one or more interfacing surfaces of said inner seat and said outer seat.

2. The self-energizing valve seat of claim 1 further comprising one or more preload springs.

3. The self-energizing valve seat of claim 1 wherein a first of said plurality of check seals is positioned to control the flow of the fluid traveling along a first of said at least two different outside diameters.

4. The self-energizing valve seat of claim 3 wherein a second of said plurality of check seals is positioned to control the flow of the fluid traveling along a second of said at least two different diameters.

5. The self-energizing valve seat of claim 1 wherein said at least two different outside diameters and said at least two different inside diameters form a gap at a location between said inner seat and said outer seat.

6. The self-energizing valve seat of claim 1 wherein said self-energizing valve seat is disposed within a valve.

7. The self-energizing valve seat of claim 6 further comprising a plurality of electrical sensors disposed on said valve and positioned to monitor one or more positions or conditions of said valve.

8. A self-locking valve seal comprising:
an inner seat;
an outer seat;
a pair of check seals positioned and biased such that when installed in a valve, they allow pressurized fluid to enter an area between them but wherein said pair of check seals are oriented to disallow the pressurized fluid to escape past them after the pressurized fluid has entered the area between them; and
said pair of check seals further positioned such that force generated by the pressurized fluid that has entered the space between them causes said self-locking valve seal to exert a force against a gate of the valve.

9. The self-locking valve seal of claim 8 wherein a first of said pair of check seals is positioned on said inner seat and wherein a second of said pair of check seals is positioned on said outer seat.

10. The self-locking valve seal of claim 8 wherein a width of said inner seat is less at its proximal gate contacting surface than its width at a distal end thereof.

11. The self-locking valve seal of claim 10 wherein a width of said outer seat is greater at its proximal gate contacting surface than its width at distal end thereof.

12. The self-locking valve seal of claim 8 wherein said outer seat comprises dimensions that allow it to at least partially encircle said inner seat and wherein said inner seat comprises at least two different outside diameters, and wherein said outer seat comprises at least two different inside diameters, and further comprising a second plurality of check seals positioned to control a flow of a fluid traveling along one or more interfacing surfaces of said inner seat and said outer seat.

13. The self-locking valve seal of claim 8 further comprising at least one pre-load spring.

14. The self-locking valve seal of claim 13 wherein said at least one pre-load spring is disposed within at least one pocket of said inner seat and wherein said at least one pre-load spring is positioned to exert a force that urges said inner seat toward the gate of the valve.

15. The self-locking valve seat of claim 8 wherein said self-locking valve seat is disposed within the valve.

16. The self-locking valve seat of claim 15 further comprising a plurality of sensors disposed on said valve and positioned to monitor one or more positions or conditions of said valve.

17. A self-energizing valve seat comprising:
an inner seat;
an outer seat, said outer seat comprising dimensions that allow it to at least partially encircle said inner seat;
a polymer seal comprising a tip and a base and positioned to at least partially translate; and
an internal passage leading from a first surface of at least one of said inner seat or said outer seat to an area below said base of said polymer seal.

18. The self-energizing valve seat of claim 17 wherein said internal passage is disposed within said inner seat.

19. The self-energizing valve seat of claim 17 wherein said tip of said polymer seal is disposed between an outer surface of said inner seat and an inner surface of said outer seat.

20. The self-energizing valve seat of claim 17 wherein said first surface comprises a surface on which a pre-load spring is disposed.

21. The self-energizing valve seat of claim 17 wherein said self-energizing valve seat is disposed within a valve.

22. The self-energizing valve seat of claim 21 further comprising a plurality of sensors disposed on said valve and positioned to monitor one or more positions or conditions of said valve.

23. A redundantly sealed valve comprising:
a first canister seal;
a second canister seal, said second canister seal positioned to provide redundant sealing of said first canister seal;
a first bonnet seal ring;
a second bonnet seal ring, said second bonnet seal ring positioned to provide redundant sealing of said first bonnet seal ring;
a first stem packing; and
a second stem packing, said second stem packing positioned to provide redundant sealing of said first stem packing.

24. The redundantly sealed valve of claim 23 further comprising a first leak port communicably coupled to a location within said redundantly sealed valve that is between said first stem packing and said second stem packing.

25. The redundantly sealed valve of claim 23 further comprising:
a primary stem gland; and
a second stem gland.

26. The redundantly sealed valve of claim 23 further comprising a plurality of electrical sensors positioned to monitor one or more positions or conditions of said redundantly sealed valve.

27. The redundantly sealed valve of claim 23 further comprising:
a self-locking valve seal comprising:
an inner seat, said inner seat comprising at least two different outside diameters;
an outer seat, said outer seat comprising dimensions that allow it to at least partially encircle said inner seat;
said outer seat comprising at least two different inside diameters;
a pair of check seals positioned and biased such that when installed in said valve, they allow pressurized fluid to enter an area between them but wherein said pair of check seals are oriented to disallow the pressurized fluid to escape past them after the pressurized fluid has entered the area between them, said pair of check seals further positioned such that force generated by the pressurized fluid that has entered the space between them causes said self-locking valve seal to exert a force against a gate of said valve;
a second plurality of check seals positioned to control a flow of a fluid traveling along one or more interfacing surfaces of said inner seat and said outer seat; and
a plurality of electrical sensors positioned to monitor one or more positions or conditions of said redundantly sealed valve.

28. A method for providing sealing force of a valve seat against a valve gate, the method comprising allowing pressurized fluid from a bore of the valve to generate differential forces between an inner valve seat and an outer valve seat due to a non-consistent width of each of the inner valve seat and the outer valve seat.
